(19) United States
(12) Patent Application Publication
(10) Pub. No.: US 2009/0315865 A1
(43) Pub. Date: Dec. 24, 2009

(54) OPERATING DEVICE AND BUTTON ASSEMBLY FOR COMPUTER NUMERICAL CONTROL MACHINE

(75) Inventors: SHOU-MING LIANG, Tu-Cheng (TW); JHY-HAU CHIU, Tu-Cheng (TW); CHING-CHENG YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/262,192

(22) Filed: Oct. 31, 2008

(30) Foreign Application Priority Data
Jun. 20, 2008 (CN) 200810302248.8

(51) Int. Cl. G06F 3/033

(52) U.S. Cl. 345/184

(57) ABSTRACT

An operating device for a CNC machine includes an operating portion, an encoder, a memory unit, a microprocessor, a display unit, and a controller. The operating portion includes a rotary button and a confirm button. The encoder is connected to the rotary button and the confirm button for generating corresponding position codes. The memory unit stores a number of function menus corresponding to a number of operating instructions. The microprocessor is connected between the encoder and the memory unit for receiving the position codes from the encoder and invoking the corresponding function menus from the memory unit. The display unit is connected to the microprocessor for displaying the function menus. The controller is connected to the microprocessor for executing input instructions.

### BACKGROUND

1. Technical Field

The present disclosure relates generally to machine operation control and, particularly, to an operating device and a button assembly for a computer numerical control (CNC) machine.

2. Description of Related Art

In a CNC machine, a plurality of programs corresponding to different processes are stored in a controller. A plurality of soft keys are arranged on an operating panel of the CNC machine, each corresponding to one of the plurality of programs. When a workpiece is to be processed, a corresponding program is selected via a corresponding soft key.

Referring to FIG. 1, a CNC machine includes a display 10 configured for displaying a plurality of functions and a plurality of soft keys 12 arranged on an operating panel of the CNC machine. In use, the corresponding soft keys 12 provide selection of corresponding functions 11 when shown on the display 10. However, the large number of soft keys 12 often crowd the operating panel and make it is easier for a wrong soft key to be selected.

Therefore, an operating device for a CNC machine is desirable in order to overcome the described limitations.

### BRIEF DESCRIPTION OF THE DRAWINGS

FIG. 1 is a schematic view of a commonly used related-art operating panel of a CNC machine.

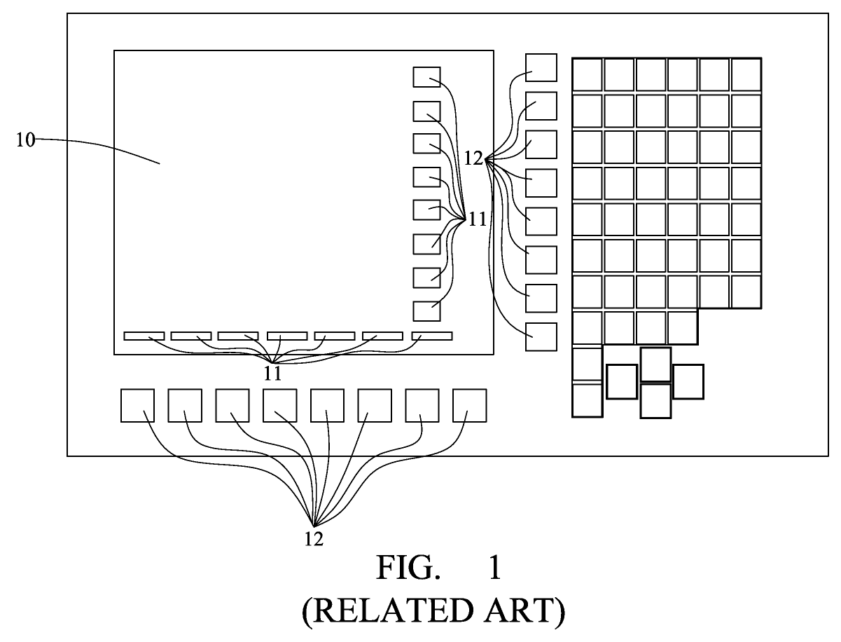

FIG. 2 is a block diagram of an exemplary operating device.

FIG. 3 is a schematic view of the operating device of FIG. 2 and an operating panel.

FIG. 4 is similar to FIG. 3, but shows the operating device of FIG. 2 and an operating panel in use.

### DETAILED DESCRIPTION OF THE EMBODIMENT

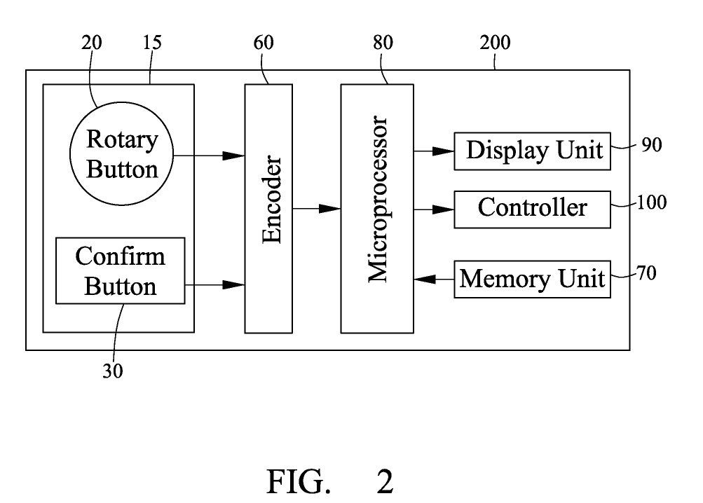

Referring to FIG. 2, an exemplary operating device 200 of a CNC machine includes an operating portion 15, an encoder 60, a memory unit 70, a microprocessor 80, a display unit 90, and a controller 100.

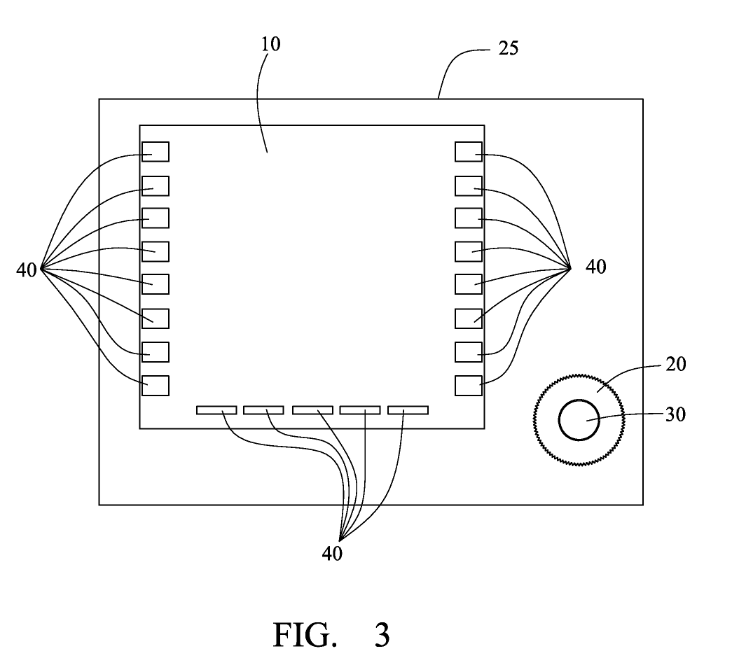

Referring to FIG. 3, the operating portion 15 includes a button assembly. The button assembly includes a rotary button 20 and a confirm button 30. The rotary button 20 is annular and arranged on an operating panel 25 of the CNC machine, and the confirm button 30 is arranged on the operating panel 25 and surrounded by the rotary button 20.

The encoder 60 is electrically connected to the rotary button 20 and the confirm button 30 via two inputs of the encoder 60, to receive position signals of the rotary button 20 and the confirm button 30, and generate corresponding position codes.

The microprocessor 80 is electrically connected to an output of the encoder 60 via a first input of the microprocessor 80. A second input of the microprocessor 80 is connected to the memory unit 70 storing a plurality of function menus 40 corresponding to a plurality of operating instructions. A first output of the microprocessor 80 is connected to the display unit 90, and a second output of the microprocessor 80 is connected to the controller 100. The microprocessor 80 receives the position codes from the encoder 60 and invokes the corresponding function menus 40 from the memory unit 70.

The display unit 90 includes a display panel 10 mounted on the operating panel 25 of the CNC machine as shown in FIG. 3. The display unit 90 is controlled by the microprocessor 80 to display the plurality of function menus 40 on the display panel 10.

The controller 100 is controlled by the microprocessor 80 to execute input instructions.

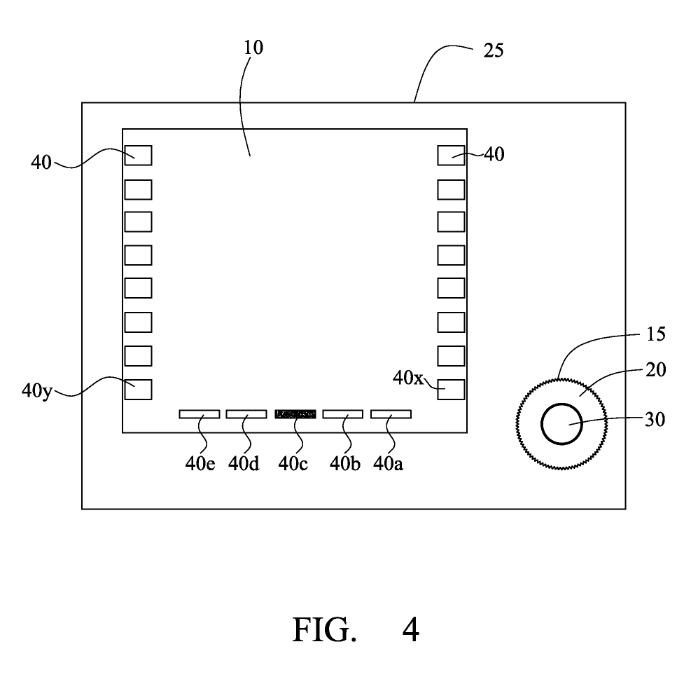

Referring to FIG. 4, in use, the CNC machine is booted. The microprocessor 80 invokes the plurality of function menus 40, and directs the display unit 90 to show the plurality of function menus 40 on the display panel 10. In an initial state, a function menu 40c, as an example here, is marked on the display panel 10. The encoder 60 generates a corresponding position code when the rotary button 20 is rotated to a certain angle, and microprocessor 80 will repeatedly mark another corresponding function menu 40 on the display panel 10. For example, a right-hand function menu 40b or 40a is marked when the rotary button 20 is rotated clockwise by a certain angle, while a left-hand function menu 40d or 40e is marked when the rotary button 20 is rotated counterclockwise by a certain angle. The confirm button 30 is used if a marked menu 40 corresponding to a required operating instruction is marked. Function menus 40 are marked in turn from a lowest function menu 40x if the rotary button 20 is rotated further clockwise, after the rightmost function menu 40a is marked. Function menus 40 will be marked in turn from a lowest function menu 40y if the rotary button 20 is rotated anticlockwise, after the leftmost function menu 40e is marked.

Furthermore, the exemplary embodiment of operating device 200 can be disposed on any appropriate location of the operating panel 25.

The foregoing description of the exemplary embodiments has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the disclosure pertains without departing from its spirit and scope. Accordingly, the scope of the disclosure is defined by the appended claims rather than the foregoing description and the exemplary embodiments described therein.

What is claimed is:

1. An operating device for a Computer Numerical Control (CNC) machine that comprises an operating panel, comprising:
an operating portion mounted on the operating panel and comprising a rotary button and a confirm button;
an encoder connected to the rotary button and the confirm button, and configured for generating corresponding position codes according to the positions of the buttons;
a memory unit for storing a plurality of function menus corresponding to a plurality of operating instructions;
a microprocessor connected between the encoder and the memory unit, and configured for receiving the position codes from the encoder and invoking the corresponding function menus from the memory unit;
a display unit connected to the microprocessor, and configured for displaying the plurality of function menus; and
a controller connected to the microprocessor, and configured for executing input instructions.

2. The operating device of claim 1, wherein the rotary button is annular.

3. The operating device of claim 1, wherein the confirm button is surrounded by the rotary button.

4. A button assembly for a machine that comprises a plurality of function menus, comprising:
a rotary button, wherein the rotary button is annular; and
a confirm button surrounded by the rotary button.

5. The button assembly of claim 4, wherein the rotary button is capable of being rotated to select one of the menus of the machine.

6. The button assembly of claim 4, wherein the confirm button is capable of being pressed to trigger a function corresponding to the selected menu.

7. A Computer Numerical Control (CNC) machine, comprising:
An operating device, comprising:
an operating portion mounted on the operating panel and comprising a rotary button and a confirm button;
an encoder connected to the rotary button and the confirm button, and configured for generating corresponding position codes according to the positions of the buttons;
a memory unit for storing a plurality of function menus corresponding to a plurality of operating instructions;
a microprocessor connected between the encoder and the memory unit, and configured for receiving the position codes from the encoder and invoking the corresponding function menus from the memory unit;
a display unit connected to the microprocessor, and configured for displaying the plurality of function menus; and
a controller connected to the microprocessor, and configured for executing input instructions.

8. The CNC machine of claim 7, wherein the rotary button is annular.

9. The CNC machine of claim 7, wherein the confirm button is surrounded by the rotary button.
